(19) United States
(12) Patent Application Publication
(10) Pub. No.: US 2003/0173828 A1
(43) Pub. Date: Sep. 18, 2003

(54) Standby power generation system, unit, and method

(76) Inventors: Thomas J. Bachinski, Lakeville, MN (US); Robb Edward Bennett, New Prague, MN (US); Gary Lee Butler, Silver Lake, MN (US); David J. Oja, Burnsville, MN (US)

Correspondence Address: MERCHANT & GOULD PC, P.O. BOX 2903, MINNEAPOLIS, MN, 55402-0903, US

(21) Appl. No.: 10/377,288

(22) Filed: Feb. 27, 2003

Related U.S. Application Data
(60) Provisional application No. 60/360,164, filed on Feb. 27, 2002.

(51) Int. Cl. H02J 7/00; H02J 9/00

(52) U.S. Cl. 307/66

(57) ABSTRACT

A standby power generation unit used to generate electrical power. The standby power unit may be connected to a combustible fuel source that supplies fuel to a combustion engine, which in turn powers an electrical generator. The unit may be installed in any structure requiring electricity or connected to any device or electrical circuit. For example, the unit may be connected to a service panel and configured to provide electricity to selected circuits of a structure or device. The unit can also be connected to the panel to provide continuous power to a limited number of circuits and delayed power to other circuits. The unit also has integrated self-diagnostics, automatic testing/starting, and computer/modem link capability. The standby power unit may include a system that automatically detects a power outage and engages to generate electricity for the structure. A messaging unit may also provide an alert when the power generation unit is activated. In addition, dial-up access to the message unit may be provided to activate or deactivate the standby power generation unit. A timer module may be included to selectively activate and deactivate the unit.

### RELATED APPLICATION

This application claims the benefit of U.S. Patent Provisional Application Serial No. 60/360,164, filed Feb. 27, 2002 and entitled Standby Power Generation Unit, the entirety of which is hereby incorporated by reference.

### FIELD OF THE INVENTION

This invention relates generally to systems, units, and methods that provide standby power during power outages. More particularly, the invention relates to systems, units, and methods that automatically detect power outages and automatically provide standby electricity.

### BACKGROUND OF THE INVENTION

Typically, electric power is provided to a structure or facility through an electric power company. Often, electric power service is interrupted due to either weather related phenomena or the increased demand for power. Although a typical power outage may only last for a couple of hours, any interruption in power of greater length may cause significant problems for a home or business owner. Even outages of the shortest duration can be problematic. For example, if power service is interrupted to a home that includes a sump pump during a rainstorm, the basement of that structure may become flooded due to the failure of the sump pump to operate. Another problem encountered during a power outage can be a lack of power to an alarm system that protects the occupants and goods contained within a home or business. Other benefits of backup power generation systems are to provide electricity during power outages to run furnaces in colder climates to eliminate pipes from freezing, medical devices for those that are ill, and refrigerators to prevent food spoilage. Further, as society has become increasingly technology driven, it has become necessary to eliminate interruptions in power service, particularly when dealing with computer-related systems.

Home and business owners have resolved some of the problems that relate to power outages by using backup or standby power generation units, such as generators. These standby power generation units can use either a variety of combustible fuels, such as gasoline, kerosene, gas, usually LP or natural gas, or combinations of these fuels. The standby units include internal combustion engines that combust the fuels to drive electrical generators to provide electricity. If a commercial power source experiences an outage, the combustion engine can be automatically started to generate power and provide electrical power to appliances and other electrical devices.

The utility and efficiency of a standby power generation system can depend upon a variety of factors. Important factors include delay times in generating power, cleaner burning of the fuel, switching over from commercial to backup power, venting of waste gases, monitoring of the standby generator, and the ease of installation. Therefore, it is desirable to provide a standby backup generation unit that increases efficiency and makes the generator more useful.

### SUMMARY OF THE INVENTION

One aspect of the present invention relates to a standby power generation unit that provides continuous power to one or more select circuits.

Another aspect of the present invention relates to a standby power generation unit that includes a device that concentrates oxygen levels in air provided for combustion within an internal combustion engine of the standby power generation unit.

Yet another aspect of the present invention relates to a standby power generation unit that includes an analog switch that allows an electrical system to switch over to backup power generation.

Yet another aspect of the present invention relates to a standby power generation unit that can exhaust waste gases from any location inside or outside a structure.

Yet another aspect of the present invention relates to a standby power generation unit that allows for the monitoring of the unit to determine if the unit is in proper working order.

Yet another aspect of the present invention relates to a standby power generation unit that allows for remote monitoring or modification of the unit.

Yet another aspect of the present invention relates to a standby power generation unit that includes a breaker that allows for direct connection to the electrical system of a structure from the unit.

Yet another aspect of the present invention relates to the use of a timing module to operate the unit at one or more selected times of the day.

Yet another aspect of the present invention relates to a standby power generation system for providing power to a circuit when commercial power is lost. The system includes a power monitor module configured to monitor the commercial power and to communicate with control module when the commercial power is lost, a generator coupled to the control module, the generator providing electrical power when the commercial power is lost and the control module starts the generator, and a battery coupled to the generator to start the generator. The system also includes a conversion module means coupled to the battery to convert power from the battery into alternating current that is provided to the circuit at least during a period between loss of the commercial power and the generation of the electrical power by the generator, thereby providing uninterrupted power to the circuit.

Yet another aspect of the present invention relates to a method for providing standby power to a circuit of a structure, including: monitoring commercial power provided to the structure to detect a loss of the commercial power; converting power from a battery to alternating current; providing the alternating current to the circuit; starting a generator with the power from the battery when loss of the commercial power is detected; and providing power from the generator to the circuit.

The above summary of the present invention is not intended to describe each disclosed embodiment or every implementation of the present invention. Figures and the detailed description that follow more particularly exemplify embodiments of the invention. While certain embodiments will be illustrated and describing embodiments of the invention, the invention is not limited to use in such embodiments.

### BRIEF DESCRIPTION OF THE DRAWINGS

Referring to the figures, wherein like numerals represent like parts throughout the several views:

FIG. 1 is a schematic cross-sectional view of an example standby power generation unit made in accordance with the present invention;

FIG. 2 is a schematic view of an example standby power generation system coupled to a source of commercial power and the wiring of a house; and

FIG. 3 is a schematic view of another example standby power generation system coupled to a source of commercial power and the wiring of a house.

The organization and manner of the structure and operation of the invention, and advantages thereof, may best be understood by reference to the following description of preferred embodiments, taken in combination with the above-referenced accompanying drawings, wherein like reference numerals identify like elements throughout the descriptions and views.

### DETAILED DESCRIPTION OF THE PREFERRED EMBODIMENTS

As used herein, the phrase “commercial power” means power typically provided by a utility company to a structure such as, for example, electrical power provided from a utility company by electrical power lines extending to the structure, or combustible gas provided by conduits running into the structure for combustion. The phrase “commercial provider” means a provider of commercial power.

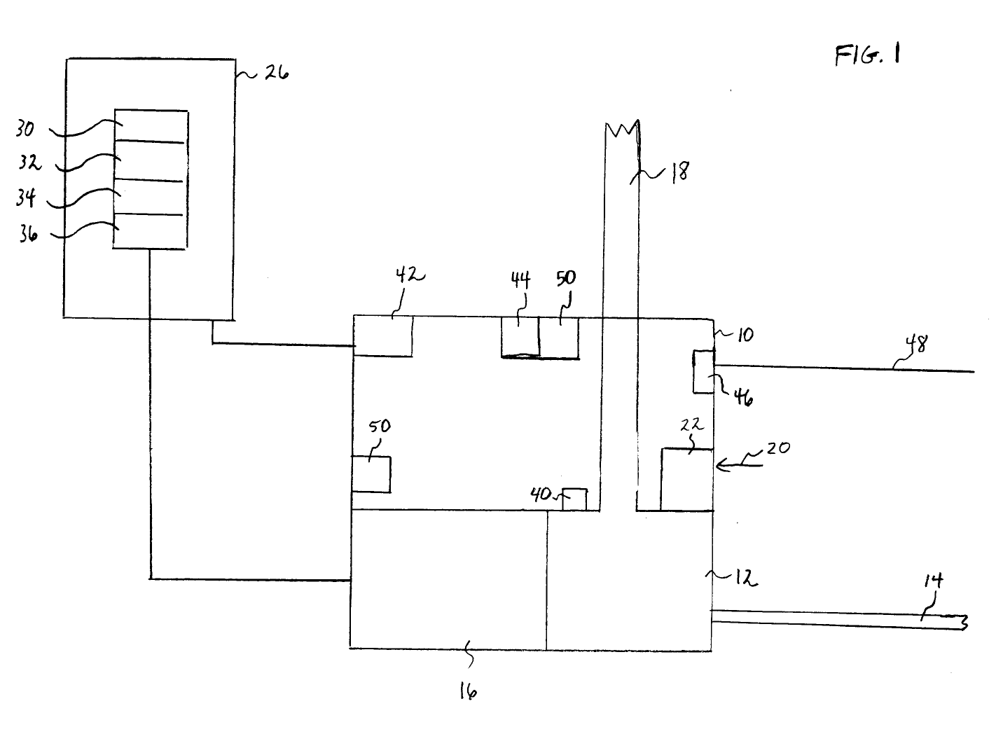

The invention relates to the use of a standby power generation unit during power outages. A standby power generation unit 10 is schematically illustrated in FIG. 1. The standby power generation unit 10 is a stationary generator that provides residential emergency standby power generation up to about 15 kilowatts (kW) with 125 amps as the capable output.

The standby power unit 10 includes an internal combustion engine 12 connected to a natural gas line 14. Alternatively, the internal combustion engine can be connected to other fuel sources, such as gasoline, kerosene, or LP gas. The unit can be installed in any structure, including, but not limited to, a home, office building, commercial building, factory, barn, garage, or any other building where electricity is provided, or connected to any device or electrical line where electricity is normally provided. Using natural or LP gas provides a relatively maintenance free unit that does not need to be refueled on a regular basis, unlike portable generators.

The natural gas or other combustible fuel is provided to the internal combustion engine 12, such as, for example, a ten-horsepower engine, housed within the unit 10. Combusting the fuel within the internal combustion engine 12 drives an electrical generator 16, such as, for example, a generator head that creates 15 kW, which creates the desired electricity when a power outage has occurred. In embodiments that locate the unit 10 within a structure, any waste gases created during combustion can be removed from the structure using a vent 18. Any conventional venting technology, such as a B-vent or a direct vent can be used. A direct vent system allows for coaxial exhaustion of waste gases and intake of fresh air for combustion.

In one embodiment, air, indicated by arrows 20, that is drawn into the standby power unit 10 for combustion passes through an oxygen concentration system 22. The oxygen concentration system 22 is used to feed pure oxygen into the carburetor of the combustion engine to increase the efficiency of combustion of the unit 10. Alternatively, the air being fed to the internal combustion engine can have only an increased level of oxygen. Any suitable oxygen concentration system can be used. In an alternative embodiment, the oxygen concentration system is connected to an air intake of a direct vent system. The oxygen concentration system 22, which typically requires 110-volts of electricity, can be powered by the unit 10 through an electrical connection (not shown) to the electrical generator 16 after the unit 10 begins generating electrical power.

In one embodiment, the unit 10 has the ability to provide continuous or uninterrupted power to items connected to critical circuits routed directly to or through a service panel 26. The critical circuits may be connected to any number of devices, such as, for example, computers, security systems, and/or home assisted medical devices, as well as any other device. The service panel 26 can include a number of circuit breakers 30, 32, 34 and 36. The unit 10 is connected to the service panel 26 and can be configured to provide electricity to all or selected circuits of the panel 26. In one embodiment, the unit 10 is connected to a limited number of circuits to power critical items such as, for example, a security system, furnace, sump pump, computer, refrigerator, and/or other selected devices. A breaker 36 on the service panel 26 provides for the direct wiring of the unit 10 to a selected electrical circuit of the structure or device to be supplied with electricity. The breaker can be selected based upon the device or appliance to which it is connected to provide continuous power.

Alternatively, the unit is constructed to provide continuous power to a limited number of critical circuits and delayed power to other non-critical circuits on the panel. The user can determine which circuits are more critical and connect the unit 10 accordingly to those breakers contained within the service panel. For example, a person that works from home on a personal computer might find the circuit to which a computer is connected critical to ensure that no information is lost, while the person finds other circuits not to be critical. The non-critical circuits can be placed on a delayed circuit, which provides full power after a delay of, for example, ten seconds.

The standby power unit 10 includes a battery 40. Following a power outage, the battery 40 provides the necessary power to start the internal combustion engine 12 and begin the generation of power through the electrical generator 16. The battery 40 can be charged by the electrical generator 16 following the initial startup of the engine 12.

The standby power unit 10 also includes a system with a power monitor 42 that automatically detects a power outage and engages the unit 10 to generate electricity for an electrical device or circuits of a structure. The system 42 includes an analog switch that has a capacitor. The capacitor acts as a bridge to the circuit or circuits of the service panel. When commercial power is being supplied to the structure or device, the capacitor is fully charged and the standby power generation unit 10 is not operating. After a power outage occurs, the capacitor begins to lose its charge. After reaching a predetermined level related to the loss of charge, the engine 12 will turn on and begin to generate electricity.

In a preferred embodiment, the generator used is a Tecumseh® 3300 watt engine/generator. Also preferred is a standard 12-volt battery. Other generators and batteries can also be used.

In one embodiment, the unit 10 also has integrated self-diagnostics, automatic testing/starting, and computer/modem link system 44. Self-diagnostic and condition monitoring and sensing allow the user of the unit 10 to install the unit 10 without further monitoring to determine if a problem exists with, for example, the charging of the battery 40.

Another device that can be used in connection with the standby power generation unit 10 during a power outage is a messaging unit 46. The messaging unit 46 may include, for example, a telephone unit connected to a telephone line 48 and be programmed to alert, for example, the owner of the structure that backup power is being used. In the alternative, the telephone unit includes a cellular transmitter for contacting the owner through cellular telephone networks.

The telephone unit can be programmed to dial more than one number stored in a memory device to inform others of the power outage, such as a neighbor or family member. Also, the telephone unit can operate to selectively dial a particular number to communicate a particular message corresponding to the specific sensor assembly that originated the first emergency signal.

In addition, a person can dial up to the telephone unit to activate or deactivate the standby power generation unit 10.

In another embodiment of the invention, the unit 10 may include a timer module 50 that is programmable to turn the unit 10 on and off periodically. This timer module 50 may be used, for example, to turn the unit 10 on during certain portions of the day, such as during peak electricity usage, during which use of the electricity generated by the unit 10 may be cheaper than purchasing electricity from a commercial provider of electricity.

The unit 10 is constructed to have an appearance of an air conditioning unit. Alternatively, the standby power generation unit can be constructed to have any appearance. The unit 10 can be constructed to be compliant with local sound ordinances.

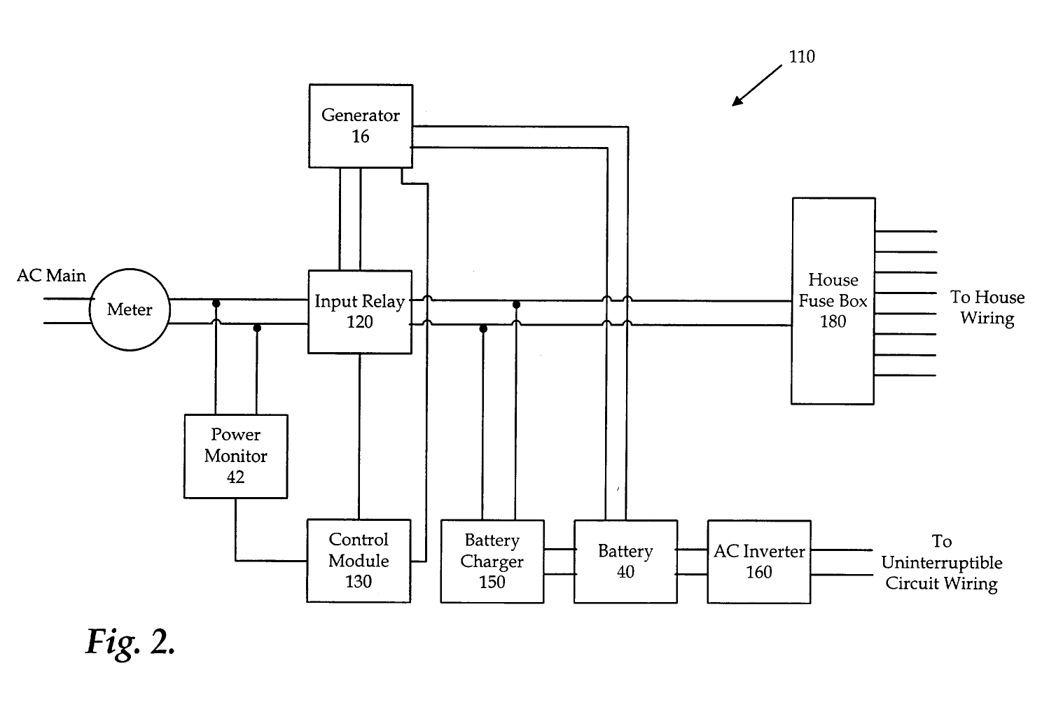

Referring now to FIG. 2, an example standby power generation system 110 is illustrated. The system 110 is illustrated as a plurality of logical units including an input relay 120, control module 130, battery charger 150, and a conversion module means including an alternating current (AC) inverter 160. Also included are the generator 16, the power monitor 42, and the battery 40. Although the system 110 is illustrated as discrete logical units, these units may be contained in a single housing or may be included in one or more separate housings.

The example system 110 functions as follows. During periods when commercial power is available and desired, electricity from a utility is provided through a meter 180 of the house and is provided from an input relay 120 to a fuse box 180 of the house. From the fuse box 180, electricity is distributed throughout the structure by the structure wiring to various outlets in the house.

In addition, commercial electricity is provided to the battery charger 150, which is in turn coupled to the battery 40. The commercial power supplied to the battery charger 150 is used to charge the battery 40 to maintain battery 40 in a charged state. Further, the battery 150 is coupled to the AC inverter 160, which is used to convert the voltage from the battery 40, in a preferred embodiment approximately 12-volts direct current (DC), into 110-volts AC at approximately 15 amps. Other conversion module means can be used to convert the DC voltage from the battery to the necessary AC voltage. For example, an electric motor can be driven by the battery to generate the alternating current.

The output of the AC inverter is coupled to an uninterruptible circuit wiring that is run to one or more circuits for which uninterrupted power is desired. Alternatively, the output of the AC inverter can be routed through the fuse box 180 to one or more desired circuits.

When commercial power is lost, the power monitor 42 detects the loss of commercial power and communicates the loss to the control module 130. The control module 130 causes the generator 16 to start up (using power from the battery 40), and the control module 130 switches the input relay 120 to draw power from the generator 16 rather than the commercial power source. The generator 16 is thereby able to provide power in a manner similar to that of the commercial power source.

However, during the interval between the loss of commercial power and the start up of the generator 16 (and preferably substantially simultaneous with the start up of the generator), uninterrupted power is continually provided to the uninterruptible circuit wiring through conversion of the power provided by the battery 40 to the AC inverter 160. In this manner, the uninterruptible circuit wiring is never without power.

Once commercial electrical power is restored, the power monitor 42 detects the return of commercial power and communicates with the control module, which switches the input relay back to drawing power from the commercial power source and turns off the generator 16.

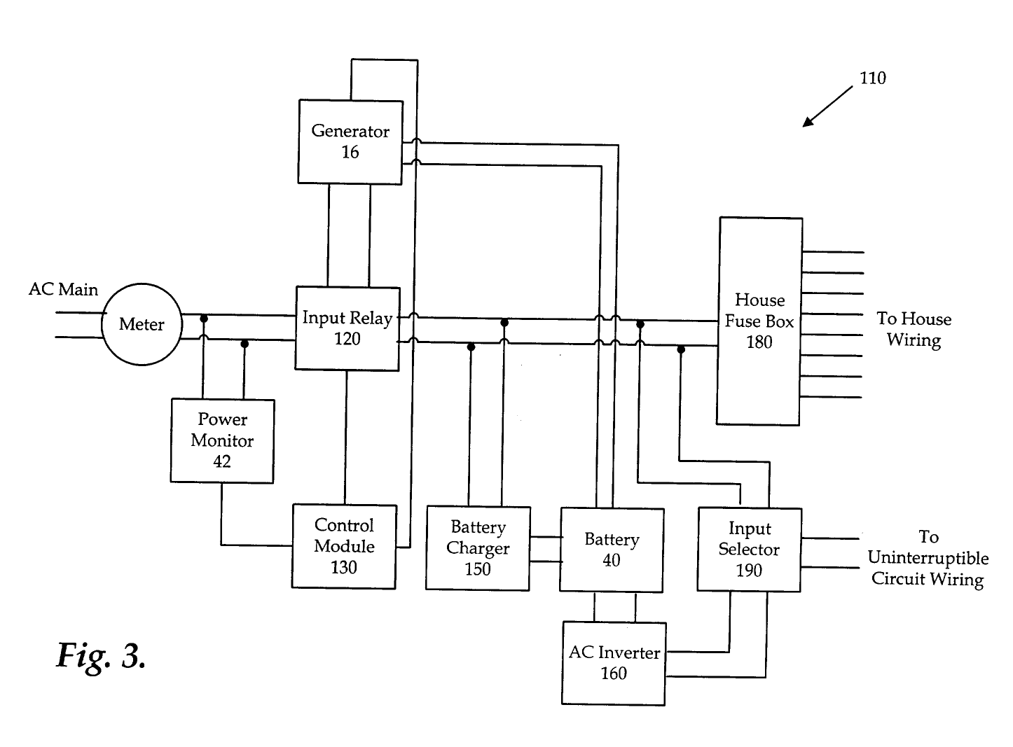

Referring now to FIG. 3, another example standby power generation system 210 is shown. The system 210 is similar in most respects to that of system 110, except that an input selector 190 is provided. The input selector 190 is controlled by the control module 130 to select between input from the commercial power source or generator when available and the inverted electricity from the battery 40 when the commercial power source and the generator are not available. Preferably, electricity from the battery 40 is provided to the uninterruptible circuit wiring so that less than 10 cycles in a 60-cycle system are lost. However, preferred switching times between commercial and standby power can vary depending on requirements of the load.

Utilizing the unit 10 and systems 110 and 120 described above, power is provided in an efficient manner with little or no interruption using the battery and can be maintained indefinitely when the generator is started.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A standby power generation system for providing power to a circuit when commercial power is lost, the system comprising:
a power monitor module configured to monitor the commercial power and to communicate with a control module when the commercial power is lost;
a generator coupled to the control module, the generator providing electrical power when the commercial power is lost and the control module starts the generator;
a battery coupled to the generator to start the generator; and
a conversion module means coupled to the battery to convert power from the battery into alternating current that is provided to the circuit at least during a period between loss of the commercial power and the generation of the electrical power by the generator, thereby providing uninterrupted power to the circuit.

2. The system of claim 1, further comprising an input selector positioned between the generator, the battery, and the circuit to select between power provided by the generator and power provided by the battery.

3. The system of claim 1, further comprising an input relay coupled to the commercial power and the electrical power of the generator, the input relay being controlled by the control module to switch between the commercial power and the electrical power of the generator.

4. The system of claim 1, wherein the conversion module means includes an alternating current inverter to convert the power from the battery into alternating current.

5. The system of claim 1, wherein the generator is configured to run on a combustible fuel source.

6. The system of claim 5, wherein the combustible fuel source is natural gas.

7. The system of claim 1, wherein loss of power for the circuit is less than approximately ten cycles for a sixty-cycle system.

8. A standby power generation system for use inside a structure for providing uninterrupted power to a circuit of the structure when commercial power is lost, the structure including a plurality of circuits, the system comprising:
a power monitor module coupled to an input of the commercial power to the structure, the power monitor module being configured to monitor the commercial power and to communicate with a control module when the power monitor module detects that commercial power has been lost;
a generator coupled to the control module, the generator being powered by a combustible fuel source provided continuously by a commercial provider, the generator providing electrical power when the commercial power is lost and the control module starts the generator;
a battery coupled to the generator to start the generator; and
an alternating current inverter coupled to the battery to convert power from the battery into alternating current that is provided to the circuit during a period between loss of the commercial power and the generation of the electrical power by the generator, thereby providing uninterrupted power to the circuit of the structure.

9. The system of claim 8, wherein the electrical power from the generator is provided only to the circuit.

10. The system of claim 8, wherein the electrical power from the generator is provided to the plurality of circuits of the structure.

11. The system of claim 8, further comprising an input selector positioned between the generator, the battery, and the circuit to select between power provided by the generator and power provided by the battery.

12. The system of claim 8, further comprising an input relay coupled to the commercial power and the electrical power of the generator, the input relay being controlled by the control module to switch between the commercial power and the electrical power of the generator.

13. The system of claim 8, wherein the combustible fuel source is natural gas provided continuously by a commercial provider.

14. A method for providing standby power to a circuit of a structure, comprising:
monitoring commercial power provided to the structure to detect a loss of the commercial power;
converting power from a battery to alternating current;
providing the alternating current to the circuit;
starting a generator with the power from the battery when loss of the commercial power is detected; and
providing power from the generator to the circuit.

15. The method of claim 14, further comprising:
monitoring the commercial power provided to the structure to detect when commercial power is restored;
providing the commercial power to the circuit when the commercial power returns; and
shutting off the generator.

16. The method of claim 14, wherein the steps of converting power, providing alternating current, and starting the generator are performed at approximately a same time.

17. The method of claim 14, further comprising powering the generator with a combustible gas.

18. The method of claim 14, further comprising:
providing the power from the generator to some of a plurality of circuits of the structure; and
delaying power provided from the generator to some of the plurality of circuits of the structure.
